(19) United States
(12) Patent Application Publication
(10) Pub. No.: US 2026/0158551 A1
(43) Pub. Date: Jun. 11, 2026

(54) METHODS FOR FORMING BIMETALLIC STRUCTURES AND ASSOCIATED STRUCTURES

(71) Applicant: Battelle Energy Alliance, LLC, Idaho Falls, ID (US)

(72) Inventors: Arin S. Preston, Idaho Falls, ID (US); Jorgen F. Rufner, Idaho Falls, ID (US); Michael J. Moorehead, Rigby, ID (US)

(21) Appl. No.: 19/178,494

(22) Filed: Apr. 14, 2025

Related U.S. Application Data
(60) Provisional application No. 63/639,461, filed on Apr. 26, 2024.

(51) Int. Cl. B22F 7/04; B32B 15/01

(52) U.S. Cl. CPC B22F 7/04; B32B 15/012; B22F 2301/052; B22F 2301/35; B32B 2250/02

(57) ABSTRACT

A method of forming a bimetallic structure includes positioning a first material on a second material, where the first material includes a solid material and the second material includes a powder. The method further includes heating the first material and the second material to a sintering temperature while applying pressure to the first material and the second material. The method also includes forming a structure wherein the first material is fused to the second material and both the first material and the second material are solid materials. Bimetallic structures are also disclosed.

### CROSS-REFERENCE TO RELATED APPLICATIONS

This application claims the benefit under 35 U.S.C. § 119(e) of U.S. Provisional Patent Application Ser. No. 63/639,461, filed Apr. 26, 2024, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

Methods for forming metallic structures are disclosed. More specifically, methods for bimetallic structures and the associated devices and structures are disclosed.

### BACKGROUND

Bimetallic structures are used to form joints between dissimilar materials in a larger structure in lieu of mechanical connections such as nuts and bolts. Bimetallic structures are often formed between two materials that are difficult to bond together, such as due to molecular differences, differences in melting points, ferrous and non-ferrous, etc. Conventionally bimetallic structures are formed through processes, such as explosion welding or friction welding, where impact forces are used to join materials that are difficult to join through simpler methods, such as welding, soldering, etc. Explosion welding and friction welding are expensive processes and require advanced technology and expert operators.

### SUMMARY

Embodiments of the disclosure include a method of forming a bimetallic structure. The method includes positioning a first material on a second material, wherein the first material includes a fully dense solid material and the second material includes a powder. The method further includes heating the first material and the second material to a sintering temperature while applying pressure to the first material and the second material. The method also includes forming a structure wherein the first material is fused to the second material and both the first material and the second material are fully dense solid materials.

Another embodiment of the disclosure includes a bimetallic structure. The bimetallic structure includes a first material. The bimetallic structure further includes a second material joined to the first material through a sintered connection. The bimetallic structure also includes an engineered interface between the first material and the second material.

Other embodiments of the disclosure include a bimetallic structure. The bimetallic structure includes a first material bonded to a second material, wherein a first melting temperature of the first material is highly dissimilar from a second melting temperature of the second material. The bimetallic structure further includes the first material having a first grain structure that is substantially uniform proximate an interface between the first material and the second material. The bimetallic structure also includes the second material having a second grain structure that is substantially uniform proximate the interface between the first material and the second material.

### BRIEF DESCRIPTION OF THE DRAWINGS

While the specification concludes with claims particularly pointing out and distinctly claiming embodiments of the disclosure, the advantages of embodiments of the disclosure may be more readily ascertained from the following description of embodiments of the disclosure when read in conjunction with the accompanying drawings in which:

FIG. 1 illustrates a schematic view of a sintering assembly;

FIGS. 2-5 illustrate enlarged views of a transition region of embodiments of bimetallic structures in accordance with embodiments of the disclosure;

FIGS. 6 and 7 illustrate embodiments of bimetallic structures formed in accordance with embodiments of the disclosure;

FIG. 8A illustrates an isometric view of a bimetallic structure formed in accordance with embodiments of the disclosure;

FIG. 8B illustrates a cross-sectional view of the bimetallic structure of FIG. 8A; and

FIG. 9 illustrates a flow chart representative of a method of forming a bimetallic structure in accordance with embodiments of the disclosure.

### DETAILED DESCRIPTION

The following description provides specific details, such as material compositions, shapes, and sizes, in order to provide a thorough description of embodiments of the disclosure. However, a person of ordinary skill in the art would understand that the embodiments of the disclosure may be practiced without employing these specific details. Indeed, the embodiments of the disclosure may be practiced in conjunction with conventional techniques employed in the industry.

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the terms “configured” and “configuration” refers to a size, a shape, a material composition, a material distribution, orientation, and arrangement of at least one feature (e.g., one or more of at least one structure, at least one material, at least one region, at least one device) facilitating use of the at least one feature in a pre-determined way.

As used herein, the term “substantially” in reference to a given parameter means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” in reference to a numerical value for a particular parameter is inclusive of the numerical value and a degree of variance from the numerical value that one of ordinary skill in the art would understand is within acceptable tolerances for the particular parameter. For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, relational terms, such as “below,” “lower,” “bottom,” “above,” “upper,” “top,” and the like, may be used for ease of description to describe one element's or feature's relationship to another element(s) or feature(s) as illustrated in the drawings. Unless otherwise specified, the spatially relative terms are intended to encompass different orientations of the materials in addition to the orientation depicted in the figures. For example, if materials in the figures are inverted, elements described as “below” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, the term “and/or” means and includes any and all combinations of one or more of the associated listed items.

As used herein, the terms “vertical,” “longitudinal,” “horizontal,” and “lateral” are in reference to a major plane of a structure and are not necessarily defined by earth's gravitational field. A “horizontal” or “lateral” direction is a direction that is substantially parallel to the major plane of the structure, while a “vertical” or “longitudinal” direction is a direction that is substantially perpendicular to the major plane of the structure. The major plane of the structure is defined by a surface of the structure having a relatively large area compared to other surfaces of the structure.

When forming structures, multiple different materials may be used. This will result in interfaces between the different materials. In some instances, bimetallic structures are used to form the interfaces where each material in the bimetallic structure interfaces with a similar material in a primary structure and the interface in the bimetallic structure forms the interface between the two materials. The interface between the materials is generally where a failure may occur in the structure. Thus, strengthening the interface or forming the interface in a manner that increases a strength of the interface may increase a strength of the resulting structure. Many materials have properties (e.g., characteristics) that make it difficult to form a strong interface. Some examples of material pairs with characteristics that make it difficult to form a strong interface are aluminum and 300 series stainless steel, copper alloys and 300 series stainless steel, tungsten and copper alloys, molybdenum and copper alloys, copper and aluminum alloys, and aluminum alloys and iron alloys. One of the characteristics of the dissimilar materials that makes it difficult to form a strong interface may be different melting temperatures (e.g., differences on the order of hundreds of degrees or thousands of degrees). As used herein, melting temperatures that are highly dissimilar means and includes any time the melting temperature range of one material is less than the sintering temperature range of a second material, such that the second material cannot be sintered without melting the first material. When melting temperatures are highly dissimilar, such that a melting temperature of one material is below a sintering temperature of the other material, it may be difficult to form a strong bond between the two materials at least because the lower temperature material may melt before the other material may be successfully bonded to the other material. Joining these types of materials is conventionally accomplished through expensive and complex processes, such as explosion welding or friction welding that join the two materials together to form a bimetallic structure. These processes do not provide precise control over the interface between the materials. Embodiments of the disclosure provide lower cost alternative methods for joining two dissimilar materials to form bimetallic structures that also provide greater control over the interface between the materials. The joining processes according to embodiments of the disclosure may be used to join pipes of dissimilar materials or in heat transfer devices. The dissimilar materials may be joined without using flanges, bolts, fasteners, or other mechanical mechanisms.

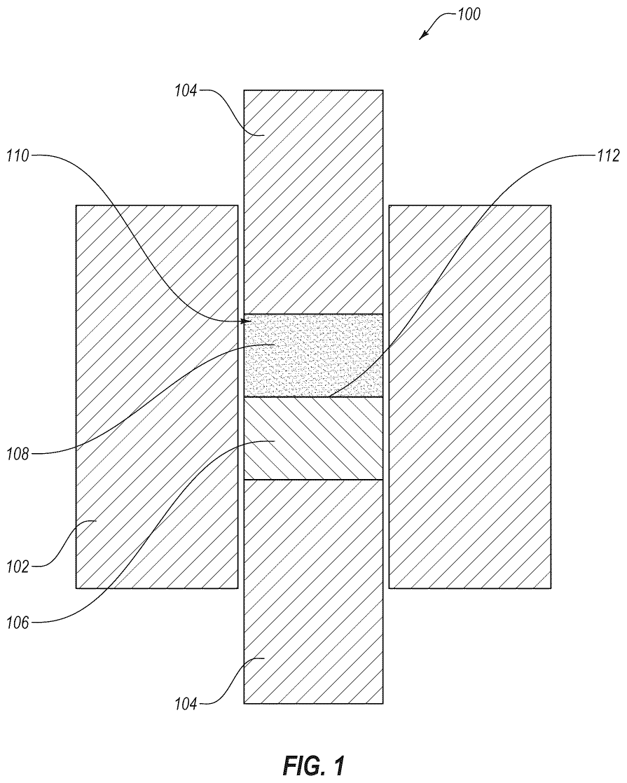

FIG. 1 illustrates a sintering assembly 100 that may be used to join two dissimilar materials through a sintering process. The sintering assembly 100 may be a conventional sintering assembly configured to heat materials while applying a pressure to the materials to form a solid material. In some embodiments, the sintering assembly 100 is an electric field assist sintering (EFAS) assembly configured to apply a pressure to a material while heating the material and sintering assembly 100 by passing an electric current through the sintering assembly 100 and the material.

The sintering assembly 100 includes a mold 102 defining a cavity 110 within the mold 102 configured to receive the material(s) to be sintered. The sintering assembly 100 also includes one or more rams 104 configured to apply pressure to the material in the cavity 110 of the mold 102. In the embodiment illustrated in FIG. 1, the sintering assembly 100 includes two opposing rams 104 positioned on opposing sides of the mold 102 and configured to apply a pressure to the material in the cavity 110 defined in the mold 102 and between the two rams 104. In an EFAS assembly, a voltage is applied between the two rams 104 to induce an electric current from the first ram 104, through the mold 102 and the materials in the cavity 110, and out the second ram 104. The electrical current passing through the mold 102 and the materials in the cavity 110 generates heat in the mold 102 and the materials in the cavity 110 based on the resistance of the material of the mold 102 and the materials in the cavity 110 to the electrical current.

In a conventional sintering process, the materials to be sintered are disposed in the cavity 110 in a powdered or granulated form. A pressure is then applied to the cavity 110 through the rams 104 and a temperature of the mold 102 is raised to a sintering temperature of the material within the cavity 110. The sintering temperature is less than the melting temperature of the material but high enough that the individual particles in the powdered or granulated material coalesce (e.g., fuse) together under pressure to form a solid material.

In an embodiment where the sintering assembly 100 is used to join two dissimilar materials, the cavity 110 will include a first material 106 and a second material 108. At least one of the first material 106 and the second material 108 is a solid material (e.g., a substantially fully dense material), such as a machined material (e.g., a material machined to a desired size from a larger solid material or billet material) or a previously sintered material. Another of the first material 106 and the second material 108 is in a powder material form or granulated material form. For example, in the embodiment illustrated in FIG. 1, the first material 106 is a solid material and the second material 108 is a powder material or granulated material. The first material 106 may be a fully dense, solid material. The powdered or granulated material is selected to be the material exhibiting the lower melting point of the materials being joined. For example, in the embodiment illustrated in FIG. 1, the second material 108 has a lower melting temperature than the first material 106. An interface surface of the first material 106 may optionally be polished, smoothed, or texturized before conducting the sintering process.

The sintering assembly 100 then applies pressure to the first material 106 and the second material 108 in the cavity 110 with the rams 104. While the pressure is being applied by the rams 104, the temperature of the sintering assembly 100 is raised to a temperature above a sintering temperature of the second material 108 and below a melting temperature of the second material 108. In an EFAS system the electrical current passed between the materials in the cavity 110 generates sufficient heat to increase the temperature. While the first material 106 and the second material 108 are maintained at the elevated pressure and temperature, the individual particles of the second material 108 fuse together to form a solid material. In addition, the individual particles of the second material 108 that are adjacent to the first material 106 fuse with an interface surface 112 of the first material 106. Thus, when the elevated pressure and temperature are removed (e.g., discontinued) the result is a structure including two solid materials (the first material 106 and the second material 108) fused together at the interface surface 112. By adjusting the pressure and electrical current during the EFAS process, properties of the interface between the materials may be tuned. The interface properties that are achieved are improved relative to conventional sintering processes. For example, the temperature may be increased for a short period of time near an end of the sintering process by increasing the electrical current for a short period of time, while maintaining the temperature within the sintering temperature range of the second material 108. The increase of temperature for a short period of time may facilitate increased bonding between the first material 106 and the second material 108 at the interface surface 112.

Fusing the particles of the second material 108 to the interface surface 112 of the first material 106 may result in the final structure having a shear strength at the interface between the first material 106 and the second material 108 that is at least as strong as a shear strength of the weakest material of the first material 106 and the second material 108. As discussed above, the interface between the two materials is where the failure is most likely to occur. Therefore, increasing the strength of the interface to be at least as strong as the weakest material may result in a structure that is stronger than similar structures formed through other processes.

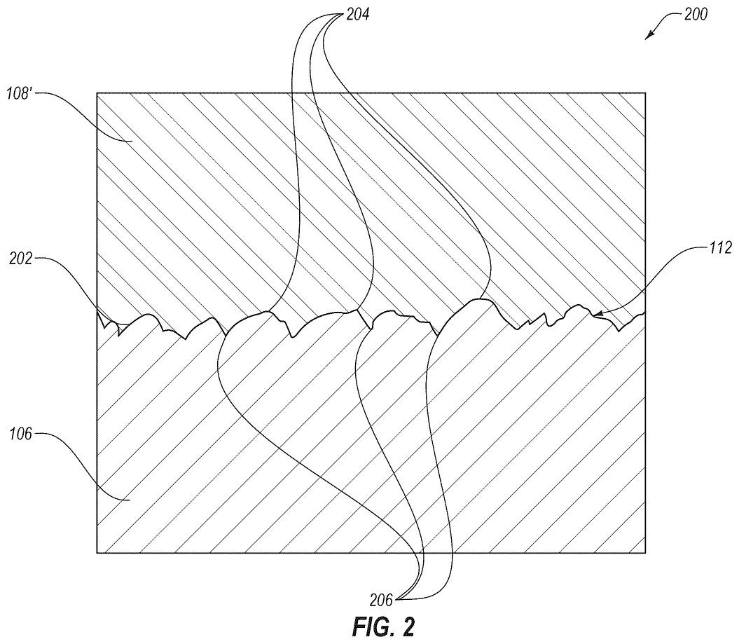

FIGS. 2-4 illustrate enlarged views of structures formed in the above process at the interface between the first material 106 and the second material 108. The shape and arrangement of the interface between the first material 106 and the second material 108 may be defined by the interface surface 112 of the first material 106, which is the material that was a solid before the sintering process described above. The processes according to embodiments of the disclosure may be achieved without using a binder.

For example, FIG. 2 illustrates a bimetallic structure 200 where the first material 106 exhibits an interface surface 112 that was finished through a rough abrasive process, such as sanding or grinding. The rough abrasive process may result in a non-uniform pattern of peaks 204 and valleys 206 across the interface surface 112. The powdered second material 108 may conform to the non-uniform pattern of peaks 204 and valleys 206 when disposed in the cavity 110 (FIG. 1) adjacent to the first material 106.

When the pressure and temperature are applied to the second material 108 and the first material 106 by the sintering assembly 100 (FIG. 1) during the sintering process, the second material 108 may form a solid second material 108′ having complementary geometry to the interface surface 112 of the first material 106 at an interface 202 between the first material 106 and the solid second material 108′. As discussed above, the particles of the second material 108 adjacent to the interface surface 112 of the first material 106 may become fused to the first material 106 in a similar manner to the fused connections being formed between the individual particles of the first material 106 during the sintering process. An irregular geometry at the interface 202, such as the interface 202 illustrated in FIG. 2, may increase a contact area between the first material 106 and the second material 108, such that a greater number of fused connections are formed between the individual particles of the solid second material 108′ and the interface surface 112 of the first material 106. The increased contact area may increase a strength of the fused bond between the first material 106 and the solid second material 108′. By way of example only, intermetallic bonds may be formed between the first material 106 and the solid second material 108′.

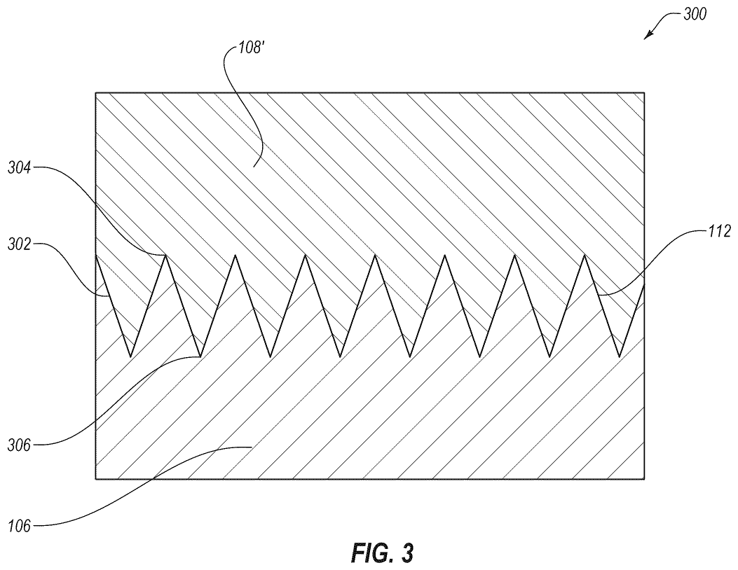

FIG. 3 illustrates a bimetallic structure 300 where the first material 106 exhibits an interface surface 112 that was engineered and formed through a forming process, such as machining, casting, sintering, additive manufacturing, or forging. The engineered interface surface 112 includes a substantially uniform pattern of peaks 304 and valleys 306 across the interface surface 112. In the embodiment illustrated in FIG. 3, the engineered interface surface 112 features a saw-tooth pattern of peaks 304 and valleys 306 that are uniformly sized, shaped, and spaced. The powdered second material 108 may conform to the uniform pattern of peaks 304 and valleys 306 when disposed in the cavity 110 (FIG. 1) adjacent to the first material 106.

When the pressure and temperature are applied to the second material 108 and the first material 106 by the sintering assembly 100 (FIG. 1) during the sintering process, the second material 108 may form a solid second material 108′ having complementary geometry to the interface surface 112 of the first material 106 at an interface 302 between the first material 106 and the solid second material 108′. As discussed above, the particles of the second material 108 adjacent to the interface surface 112 of the first material 106 are fused to the first material 106 in a similar manner to the fused connections being formed between the individual particles of the first material 106 during the sintering process. A substantially uniform pattern geometry at the interface 302, such as the interface 302 illustrated in FIG. 3, may increase a contact area between the first material 106 and the solid second material 108′, such that a greater number of fused connections are formed between the individual particles of the solid second material 108′ and the interface surface 112 of the first material 106. The increased contact area may increase a strength of the fused bond between the first material 106 and the solid second material 108′. By way of example only, intermetallic bonds may be formed between the first material 106 and the solid second material 108′.

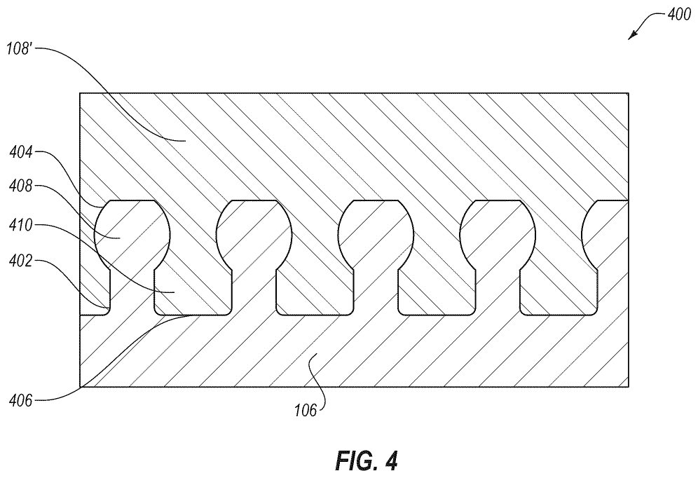

FIG. 4 illustrates a bimetallic structure 400 where the first material 106 exhibits an interface surface 112 that was engineered and formed through a forming process, such as machining, forging, casting, additive manufacturing, or sintering. The engineered interface surface 112 includes a uniform pattern of peaks 404 and valleys 406 across the interface surface 112. In the embodiment illustrated in FIG. 4, the engineered interface surface 112 features an interlocking pattern of primary nodes 408 formed on the peaks 404 and secondary nodes 410 formed in the valleys 406 that are uniformly sized, shaped, and spaced. The powdered second material 108 may conform to the uniform pattern of peaks 404 and valleys 406 when disposed in the cavity 110 (FIG. 1) adjacent to the first material 106.

When the pressure and temperature are applied to the second material 108 and the first material 106 by the sintering assembly 100 (FIG. 1) during the sintering process, the second material 108 may form a solid second material 108′ having complementary geometry to the interface surface 112 of the first material 106 at an interface 402 between the first material 106 and the solid second material 108′. As discussed above, the particles of the second material 108 adjacent to the interface surface 112 of the first material 106 are fused to the first material 106 in a similar manner to the fused connections being formed between the individual particles of the first material 106 during the sintering process. A uniform pattern geometry at the interface 402, such as the interface 402 illustrated in FIG. 4, may increase a contact area between the first material 106 and the solid second material 108′, such that a greater number of fused connections are formed between the individual particles of the solid second material 108′ and the interface surface 112 of the first material 106. The increased contact area may increase a strength of the fused bond between the first material 106 and the solid second material 108′. By way of example only, intermetallic bonds may be formed between the first material 106 and the solid second material 108′.

Furthermore, in the embodiment illustrated in FIG. 4, when the second material 108 fuses into a solid second material 108′ after the sintering process, the solid second material 108′ in the valleys 406 may form secondary nodes 410 configured to interlock with the primary nodes 408 of the first material 106. The interlocking primary nodes 408 and secondary nodes 410 may be configured to provide additional mechanical strength to the interface 402 to resist forces in an axial and/or lateral direction.

As discussed above, highly dissimilar materials are conventionally joined together to form bimetallic structures through processes involving high impact forces, such as explosion welding or friction welding. These conventional processes result in highly irregular structures at the interface (e.g., interface 202, 302, 402) between the two materials. The high impact forces also result in irregular grain structures near the interface, which may result in the material being weaker near the interface.

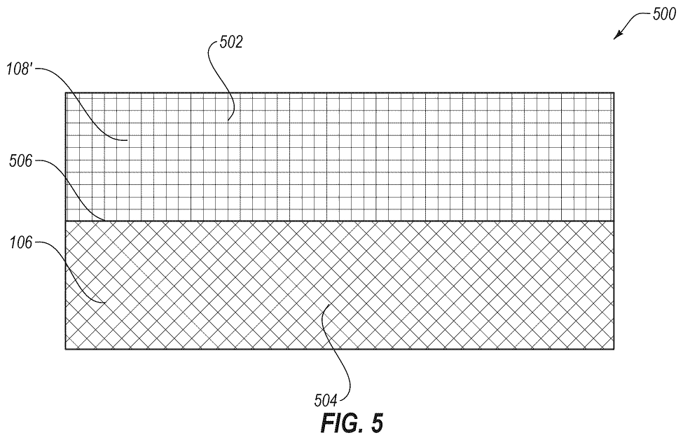

FIG. 5 illustrates an embodiment of a bimetallic structure 500 formed in the sintering process described above. The bimetallic structure 500 includes a first material 106 and a solid second material 108′ joined at an interface 506. As discussed above, the particles of the solid second material 108′ adjacent to the first material 106 are fused to the first material 106 at the interface 506 in a similar manner to the fused connections being formed between the individual particles of the first material 106 during the sintering process. Due to the nature of the sintering process a grain structure 504 in the first material 106 may remain substantially uniform throughout the first material 106, including in the region proximate the interface 506. Similarly, a grain structure 502 in the solid second material 108′ may form in the sintering process to be substantially uniform throughout the solid second material 108′ including in the region proximate the interface 506.

As illustrated in FIG. 5, the grain structure 504 of the first material 106 is different from the grain structure 502 of the solid second material 108′. When the individual particles of the second material 108 fuse to the first material 106 at the interface 506, the differences in the grain structures 504, 502 may introduce minor irregularities in the grain structures 504, 502 in the immediate vicinity of the interface 506. However, the irregularities may not extend beyond the grains immediately adjacent the interface 506, such that the grain structures 504, 502 remain substantially uniform in the respective regions proximate the interface 506.

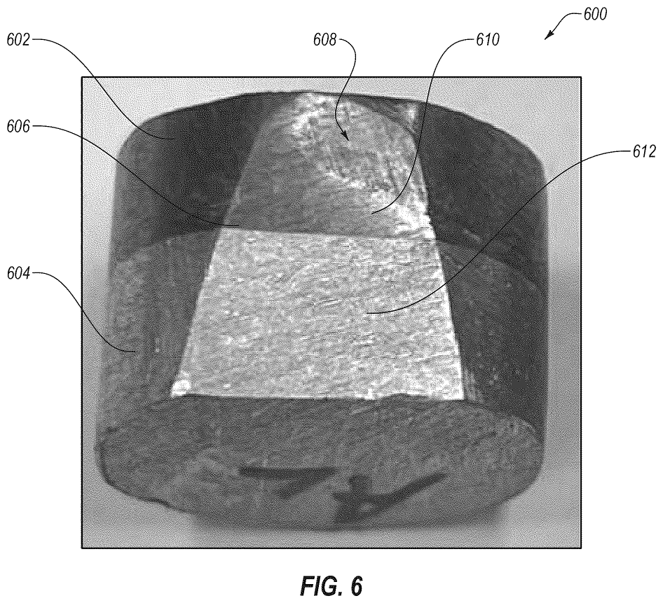

FIG. 6 illustrates an embodiment of a bimetallic structure 600 formed in the sintering process described above. The bimetallic structure 600 includes a first material 602 and a second material 604 joined at an interface 606. The first material 602 is tungsten (W) and the second material 604 is aluminum (Al). As noted above, tungsten and aluminum are two materials that are highly dissimilar and are difficult to join together by conventional processes. For example, the melting temperature of tungsten is about 6,192° F. (3,422° C.) while the melting temperature of aluminum is 1,220° F. (660° C.). Tungsten is considered a weight heavy alloy (WHA). WHAs have high density (16-18 g/cm³), high ductility (10-30%), excellent strength (1,000-1,700 MPa) and offer good corrosion resistance. WHAs also have a low coefficient of expansion and a high modulus of elasticity. Aluminum alloys have a much lower density (2.5-3 g/cm³) and strength (100-600 MPA) than WHAs. These differences in properties cause it to be difficult to bond tungsten and aluminum together. As indicated above, conventional methods of bonding tungsten and aluminum include explosion welding or friction welding.

The bimetallic structure 600 of FIG. 6 may be formed through the sintering process described above. For example, the first material 602, which is tungsten in this embodiment, is disposed in the cavity (e.g., cavity 110) of a sintering assembly (e.g., sintering assembly 100) in a solid form similar to the final size and shape of the tungsten first material 602. The second material 604, which is aluminum in this embodiment, is disposed in the cavity of the sintering assembly with the tungsten first material 602. The aluminum second material 604 is disposed in the cavity in a powdered or granulated form. As discussed above, the powdered material is the material having a lower melting point, which, in the embodiment of FIG. 6, is aluminum. After the aluminum and tungsten are disposed in the cavity, the cavity is heated and a pressure is applied to the aluminum and tungsten until the aluminum solidifies through the sintering process.

After the sintering process, the aluminum second material 604 is fused to the tungsten first material 602 at the interface 606. As discussed above, the interface 606 is controllable and matches the interface surface of the solid material, which, in this embodiment, is the tungsten first material 602. As illustrated in FIG. 6, the interface 606 is a substantially straight line and does not include any of the highly irregular features that characterize an interface formed through explosion welding or friction welding.

The bimetallic structure 600 includes a polished surface 608, where the side surface of the bimetallic structure 600 is polished to show the grain structures 610, 612 of the tungsten first material 602 and the aluminum second material 604. As illustrated in the embodiment of FIG. 6, the grain structures 610 of the tungsten first material 602 are substantially uniform up to the interface 606, and the grain structures 612 of the aluminum second material 604 are substantially uniform up to the interface 606.

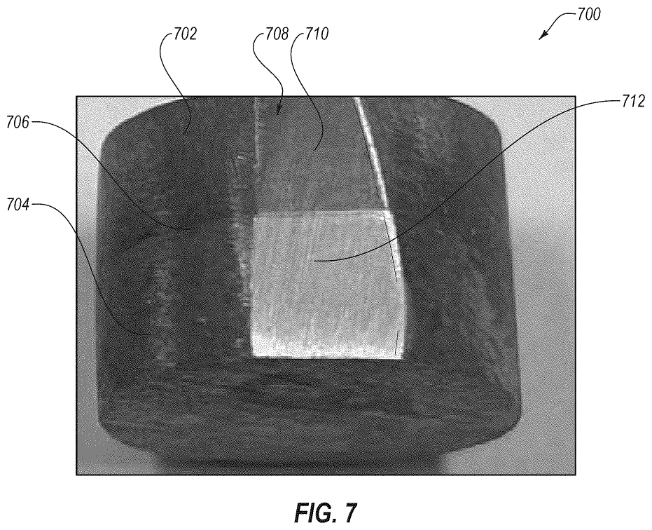

FIG. 7 illustrates another embodiment of a bimetallic structure 700 formed in the sintering process described above. The bimetallic structure 700 includes a first material 702 and a second material 704 joined through an interface material 706. The interface material 706 may facilitate a connection between two materials that are highly dissimilar by fusing the interface material 706 to each of the first material 702 and the second material 704, such that the interface material 706 forms the interface between the first material 702 and the second material 704. The interface material 706 may be used to facilitate bonding, to mitigate mismatches in a coefficient of thermal expansion of the first material 702 and the second material 704, to reduce the brittleness of the bimetallic structure 700 in the transition region, etc. In some embodiments, the interface material 706 may include multiple interface materials stacked between the first material 702 and the second material 704, such as two different interface materials 706 having different properties, where a first interface material is configured to bond to the first material 702 and a second interface material is configured to bond to the second material 704 and the first and second interface materials are configured to bond to each other strengthening the bond between the first material 702 and the second material 704. In some embodiments, one or more of the interface materials 706 may be configured to melt at the sintering temperature of the assembly. In other embodiments, the interface materials 706 may remain solid at the sintering temperature of the assembly.

In the embodiment illustrated in FIG. 7, the first material 702 is tungsten (W) and the second material 704 is copper (Cu). As noted above, tungsten and copper are two materials that are highly dissimilar and are difficult to join together. For example, the melting temperature of tungsten is about 6,192° F. (3,422° C.) while the melting temperature of copper is 1,983° F. (1,084° C.). Molecular differences between copper and tungsten make forming a direct connection very difficult because copper and tungsten do not interact chemically. Therefore, an interface material 706, such as nickel (Ni), is positioned between the tungsten and the copper to facilitate the fusion of the copper and the tungsten. As indicated above, conventional methods of bonding tungsten and copper include explosion welding or friction welding.

The bimetallic structure 700 of FIG. 7 may be formed through the sintering process described above. For example, the first material 702, which is tungsten in this embodiment, is disposed in the cavity (e.g., cavity 110) of a sintering assembly (e.g., sintering assembly 100) in a solid form similar to the final size and shape of the tungsten first material 702. An interface material 706, which is a nickel material in this embodiment, is positioned over the first material 702. In some embodiments, the interface material 706 is a thin material, such as a foil. In other embodiments, the interface material 706 may be deposited as a film, such as through sputtering, precipitation, or chemical vapor deposition. The second material 704, which is copper in this embodiment, is disposed in the cavity of the sintering assembly with the tungsten first material 702 and the nickel interface material 706, such that the nickel interface material 706 is positioned between the tungsten first material 702 and the copper second material 704. The copper second material 704 is disposed in the cavity in a powdered or granulated form. As discussed above, the powdered material is the material having a lower melting point, which in the embodiment of FIG. 7 is the copper. After the copper, nickel, and tungsten are disposed in the cavity, the cavity is heated and a pressure is applied to the copper, nickel, and tungsten until the copper solidifies through the sintering process.

After the sintering process the copper second material 704 is fused to the nickel interface material 706 and the nickel interface material 706 is fused to the tungsten first material 702, such that the copper second material 704 is operatively fused to the tungsten first material 702 through the nickel interface material 706. Similar to the embodiments described above, the interface material 706 may conform to the interface surface of the solid material, which in this embodiment is the tungsten first material 702. As illustrated in FIG. 7, the interface material 706 forms a substantially straight line and does not include any of the highly irregular features that characterize an interface formed through explosion welding or friction welding.

The bimetallic structure 700 includes a polished surface 708, where the side surface of the bimetallic structure 700 is polished to show the grain structures 710, 712 of the tungsten first material 702 and the copper second material 704. As illustrated in the embodiment of FIG. 7, the grain structures 710 of the tungsten first material 702 are substantially uniform up to the interface material 706 and the grain structures 712 of the copper second material 704 are substantially uniform up to the interface material 706.

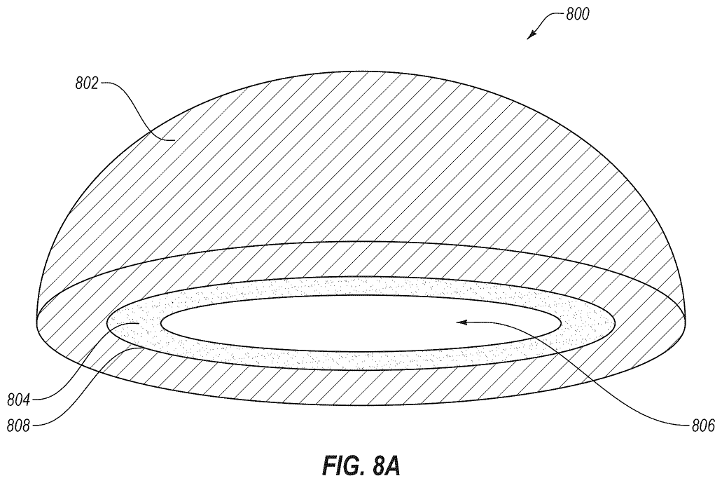

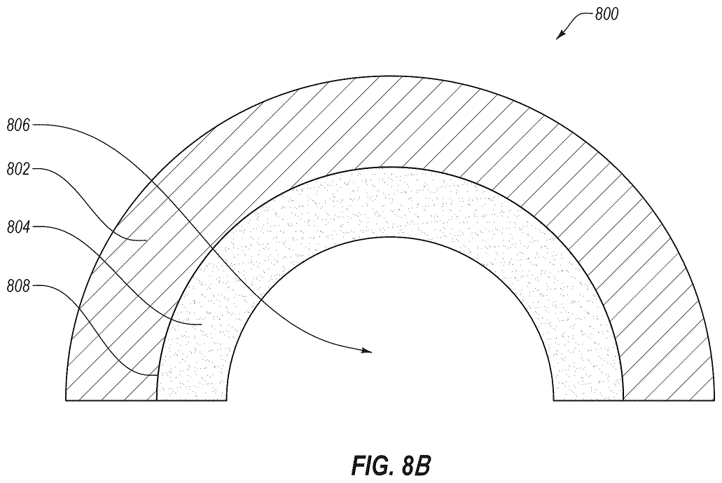

FIGS. 8A and 8B illustrate another embodiment of a bimetallic structure 800 formed through a sintering process as described above. The sintering process for forming a bimetallic structure may facilitate forming non-planar interfaces between structures. The sintering process may enable the formation of near net shape structures. For example, in the embodiment illustrated in FIGS. 8A and 8B, the bimetallic structure 800 is a dome-shaped structure where a first material 802 forms an outer surface of the dome-shaped bimetallic structure 800 and a second material 804 forms an inner surface of the dome-shaped bimetallic structure 800 defining a cavity 806 within the dome-shaped bimetallic structure 800. An interface 808 between the first material 802 and the second material 804 is dome shaped similar to the bimetallic structure 800.

In some embodiments, the dome-shaped bimetallic structure 800 is formed by positioning a dish-shaped fully densified solid material (e.g., the first material 802) with the cavity 806 facing upward and filling the cavity 806 with a powdered material (e.g., the second material 804 in a powdered form). The corresponding cavity of the sintering assembly may include complementary geometry to the final domed shape of the bimetallic structure 800, such as a dish on a first end corresponding to the domed outer shape of the bimetallic structure 800 and a domed protrusion corresponding to the inner cavity 806 of the bimetallic structure 800. The sintering assembly may then apply an axial pressure to the first and second materials in the sintering assembly cavity while heating the materials until the second material 804 is a fully densified solid material bonded to the first material 802.

In other embodiments, the dome-shaped bimetallic structure 800 is formed by positioning a dome-shaped, fully densified solid material (e.g., the second material 804) with the cavity 806 facing downward. A powdered material is positioned over the domed outer surface of the fully densified solid material to fill a cavity in the sintering assembly surrounding the dome-shaped, fully densified solid material. The sintering assembly then applies pressure and heat, conforming the powdered material to a shape defined by the cavity in the sintering assembly and the outer surface of the dome-shaped, fully densified solid material until the powdered material transitions to a fully densified solid material (e.g., the first material 802) bonded to the outer surface of the first dome-shaped, fully densified solid material, such that the first material 802 and the second material 804 form a fully densified solid bimetallic structure 800 bonded together at a dome-shaped interface 808 between the first material 802 and the second material 804.

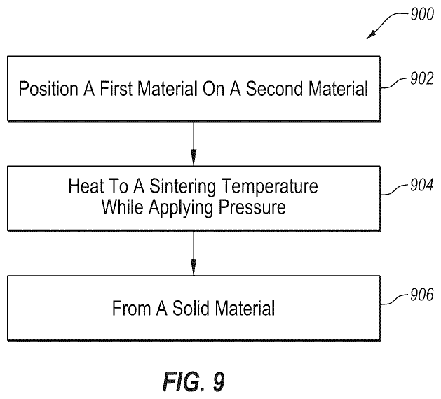

FIG. 9 illustrates a flow chart representative of a method 900 of forming a bimetallic structure according to embodiments of the disclosure. The method includes positioning a first material on a second material in act 902. As discussed above, one of the first material and the second material is a solid material and another of the first material and the second material is a powder or granulated material. The granulated or powdered material is the material of the first material and the second material that has the lowest melting point. In some embodiments, as discussed above, an optional interface material may be positioned between the first material and the second material to facilitate a fused connection between the first material and the second material.

The materials may be positioned in a cavity (e.g., cavity 110) of a sintering assembly (e.g., sintering assembly 100). The materials are then heated to a sintering temperature while a pressure is applied to the materials by the sintering assembly in act 904. The sintering temperature is less than a melting temperature of the material with the lowest melting temperature. The material with the lowest melting temperature may be one of the individual materials or a combination of the individual materials. For example, if the individual materials are gold (Au) and silicon (Si) having melting points of 1,064° C. and 1,414° C. respectively, the lowest melting point of any combination of gold and silicon is about 364° C. for an 80-20 at % Au—Si mixture. Thus, the sintering temperature would be less than about 364° to sinter these two materials together. The temperature may be applied by heating the sintering assembly, such as in a furnace or by applying an electrical current to the sintering assembly to increase the temperature through the heat generated by the electrical resistance of the assembly. The pressure is applied through a ram or press (e.g., ram 104) that forms part of the sintering assembly.

The individual particles in the powdered or granulated material may begin to fuse to adjacent particles while being heated under pressure to form a solid material in act 906. The individual particles that are adjacent to the solid material of the first material and the second material may also fuse to the solid material. Thus, after the pressure and temperature are released, the bimetallic structure formed includes two solid materials fused together at the interface.

Embodiments of the disclosure may facilitate forming bimetallic structures through a sintering process. Forming bimetallic structures in the manner described in the disclosure may facilitate a greater control over the interface between the two materials, which may facilitate using engineered interfaces. Using engineered interfaces, may provide improved strength to the bimetallic structures as well as improved predictability for the structures. Improved predictability may improve the efficiency of associated designs and reduce costs of building the associated structures.

Embodiments of the disclosure may also facilitate forming bimetallic structures from highly dissimilar materials through a sintering process. The sintering processes according to embodiments of the disclosure are substantially less expensive than conventional methods used for forming bimetallic structures from highly dissimilar materials, such as explosion welding or friction welding. Reducing the cost of forming the bimetallic structures may also reduce costs of the associated structures.

### EXAMPLE

A bimetallic structure formed through the methods of this disclosure underwent shear strength testing. The bimetallic structure included aluminum fused to 316 stainless steel with no interfacing material at the interface between the aluminum and the 316 stainless steel. The bimetallic structure was formed by fully sintering the 316 stainless steel into a solid cylinder. The solid cylinder of the 316 stainless steel was then placed in a sintering device and an aluminum powder was placed over a surface of the solid cylinder of the 316 stainless steel. No interface material or alloying material was used. A pressure of from about 30 MPa to about 35 MPa was applied while heating the structure to about 575° C. After forming the bimetallic structure, the bimetallic structure was subjected to shear testing until failure. The sample was cylindrical with a diameter of about 12 mm and the sample failed through shear when a force of 6,300 Newtons was applied to the sample. Therefore, the shear strength of the sample was found to be 55.7 MPa. Published material properties of aluminum show that un-alloyed aluminum has a shear strength in a range from about 50 MPa to about 62 MPa. Thus, the bimetallic structure tested had a shear strength that was within the shear strength range of un-alloyed aluminum, which is the weakest of the two materials (e.g., aluminum and stainless steel) used to form the bimetallic structure.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. A method of forming a bimetallic structure, the method comprising:
positioning a first material on a second material, wherein the first material comprises a fully dense solid material and the second material comprises a powder;
heating the first material and the second material to a sintering temperature while applying pressure to the first material and the second material; and
forming a structure wherein the first material is fused to the second material and both the first material and the second material are fully dense solid materials.

2. The method of claim 1, wherein heating the first material and the second material to the sintering temperature comprises heating the first material and the second material to a temperature less than a melting temperature of a lowest melting temperatures of the first material, the second material, and combinations thereof.

3. The method of claim 1, wherein positioning the first material on the second material comprises positioning the first material having a first melting temperature on the second material having a second melting temperature less than the first melting temperature of the first material.

4. The method of claim 1, further comprising positioning one or more interface materials between the first material and the second material before heating the first material and the second material to the sintering temperature.

5. The method of claim 1, further comprising forming an engineered interface into an interface surface of the fully dense solid material of the first material before positioning the first material on the second material.

6. The method of claim 5, wherein forming the engineered interface into the interface surface of the fully dense solid material of the first material comprises forming the engineered interface through one or more of machining, forging, casting, additive manufacturing, and sintering.

7. The method of claim 1, wherein positioning the first material on the second material comprises positioning the first material on the second material, wherein an interface between the first material and the second material is non-planar.

8. A bimetallic structure comprising:
a first material;
a second material joined to the first material through a sintered connection; and
an engineered interface between the first material and the second material.

9. The bimetallic structure of claim 8, wherein the first material and the second material comprise dissimilar materials.

10. The bimetallic structure of claim 8, wherein the first material has a first melting temperature less than a second melting temperature of the second material.

11. The bimetallic structure of claim 8, wherein the engineered interface comprises complementary features configured to increase a contact area between the first material and the second material.

12. The bimetallic structure of claim 11, wherein the complementary features comprise interlocking features configured to form a mechanical connection between the first material and the second material.

13. The bimetallic structure of claim 8, wherein the engineered interface comprises a uniform pattern of peaks and valleys.

14. The bimetallic structure of claim 13, wherein the uniform pattern of peaks and valleys comprises an interlocking pattern of primary nodes on the peaks and secondary nodes in the valleys.

15. The bimetallic structure of claim 8, further comprising one or more interface materials positioned between the first material and the second material along the engineered interface.

16. A bimetallic structure comprising:
a first material bonded to a second material, wherein a first melting temperature of the first material is highly dissimilar from a second melting temperature of the second material;
the first material having a first grain structure that is substantially uniform proximate an interface between the first material and the second material; and
the second material having a second grain structure that is substantially uniform proximate the interface between the first material and the second material.

17. The bimetallic structure of claim 16, further comprising an interface material positioned between the first material and the second material at the interface.

18. The bimetallic structure of claim 17, wherein the interface material comprises nickel.

19. The bimetallic structure of claim 16, wherein the interface between the first material and the second material comprises an engineered interface.

20. The bimetallic structure of claim 16, wherein the interface between the first material and the second material is non-planar.
